(19) United States
(12) Patent Application Publication
(10) Pub. No.: US 2011/0307107 A1
(43) Pub. Date: Dec. 15, 2011

(54) Temperature-dependent controller for controlling a sanitizing devise

(76) Inventors: Howard Jay Frantz, Irvine, CA (US); Michael Gideon Frantz, Irvine, CA (US); Elan Benjamin Frantz, Irvine, CA (US)

(21) Appl. No.: 12/802,699

(22) Filed: Jun. 11, 2010

(51) Int. Cl. G05D 7/00

(52) U.S. Cl. 700/283

(57) ABSTRACT

This invention is intended to be a controller for controlling a sanitizing device such as an ozone generator. Microbial populations in waste enclosures such as trash cans, dumpsters, or port-o-potties can cause odor and sanitation issues. As ambient temperature varies by time-of-day or seasonally, the growth rates of the microbial population can vary significantly. This invention modulates the activity of the sanitizing device to apply sanitizing agent when it is needed most to reduce microbial population and/or odor inside a waste enclosure. By varying the amount of sanitizing agent as a function of ambient temperature, this invention minimizes the amount of sanitizing agent required. This also may be intended to reduce energy consumption of the sanitizing devise, allowing for smaller, more cost effective solar panels and/or batteries. It may also extend the lifetime of a sanitizing device by limiting the amount of time that it is active.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND

1. Field of the Invention

The invention is in the field of waste management. The invention is intended to efficiently control the application of a deodorizing and/or sanitizing agent to waste in a waste enclosure such as a trash can, dumpster, or port-o-potty. The invention is also intended to reduce the energy used by deodorizing or sanitizing devices.

2. Advantages over Prior Art

Currently, agents like ozone are widely used to deodorize and sanitize waste enclosures such as trash cans or dumpsters. These devices are either controlled by a timer, by an on-off switch, or by % output. This invention intends to improve upon these methods by applying more sanitizing agent when the odor or microbial load is the largest, and curbing the delivery of the deodorizing or sanitizing agent when the odor or microbial load is smaller. This in turn reduces energy required to power the devise. In the case of solar or battery powered devises, this may allow for a smaller, more cost effective design.

Weinberg (Ser. No. 5,814,135) and Porat (Ser. No. 7,118,678) describe a battery powered ozone generators. Our invention improves upon battery-powered or solar-powered sanitizing devices by regulating the usage of the device using ambient temperature with the object of decreasing the energy needed to power the device, thus enabling a smaller battery and a smaller solar collector.

Conrad (Ser. No. 5,106,589) describes a method of controlling an ozone generator that uses rate of gas flow, pressure, and temperature to regulate an ozone generator. Conrad's invention, however, is used to normalize ozone production by the generator to a constant output. Our invention intends to use temperature to change the amount of sanitizing agent that is produced, rather than keep it constant. Similarly, Davidson (Ser. No. 5,540,898) describes an in-line temperature sensor used to control an ozone generator that is used to adjust for varied ozone production with temperature. This temperature sensor also is in-line, and is reading the temperature of the ozone with the goal of constant ozone production. The temperature sensor in our invention reads the ambient temperature inside an enclosure to gauge the microbial load, as to apply the correct amount of a sanitizing agent.

### SUMMARY OF THE INVENTION

Odor in waste is related to bacterial growth. When bacteria metabolize products in waste, they produce odors that people perceive as unpleasant. In cold ambient temperatures, microbes tend to have a slower growth rate and metabolize less, thus creating fewer metabolic byproducts that we perceive as odors. At optimal ambient temperatures, the metabolic rate and growth rate of the microbes increase. Once the ambient temperature is higher than optimal, the growth rates and metabolic rates drop off once more. Generally, optimal temperatures for many microbes are between 68 and 115 degrees Fahrenheit. Going below this range, microbes slow their metabolism or become dormant. Above this range, enzymes and proteins begin to denature, causing the microbes to die off. Since bacteria have slower growth rates outside the optimal range, varying the amount of a deodorizing or antimicrobial agent (hereafter referred to as a sanitation agent or sanitizing agent) with temperature enables judicious application of the agent. Thus, the device may be powered by a smaller battery, which may be charged by a smaller solar cell. It may also extend the lifetime of a sanitizing device by limiting the amount of time that it is active. The invention can be applied to different types of waste by varying the delivery of the agent as a function of temperature.

According to an embodiment of the present invention, a controller for controlling a sanitizing device, comprising a temperature-sensing component, a waste enclosure, a controlling component, and a response component, where the controlling component is configured to control the response component, and where the temperature-sensing component indirectly controls the response component through the controlling component.

In one aspect, the controller is configured such that the response element is a sanitizing device that is configured to deliver a dose of a sanitizing agent. In one aspect, the controlling component comprises a programmable unit that is configured to control a switch, which is configured to turn the response component on and off.

In one aspect, the controlling component comprises a dose-length function and a dose-interval function. The dose-length function comprises parameters of a desired concentration of the sanitizing agent, a volume of the enclosure, a rate at which the sanitizing device delivers the sanitizing agent, and an output of dose length in units of time. The dose-length function controls a length of time of activity of the sanitizing device, and comprises a temperature input from the temperature-sensing component inside the waste enclosure and a time output, which is configured to be an interval in between doses of the sanitizing agent. If one or more of odor, microbial population, or microbial metabolism increase as temperature increases, the interval between doses decreases as temperature increases. If one or more of odor, microbial population, or microbial metabolism decrease as temperature increases, the interval between doses increases as temperature increases.

In one aspect, the response element is configured to deliver the sanitizing agent into the waste enclosure.

According to another embodiment of the present invention, a method for controlling a sanitizing device, comprising a dose-length function and a dose-interval function, where the dose-interval function is configured generate a dose interval that is configured to be dependent on an ambient temperature inside an enclosure, and where the dose-length function is configured to generate a dose length that is configured to be directly proportional to a size of an enclosure, directly proportional to a desired sanitizing agent concentration, and inversely proportional to a rate of sanitizing agent production.

In one aspect, the ambient temperature inside the enclosure is measured by a temperature-sensing component configured to sense the ambient temperature inside the enclosure. The temperature-sensing component sends a signal that comprises an input to the dose-interval function. The size of the enclosure, the desired sanitizing agent concentration, and the rate of sanitizing agent production are configured to be input into the dose-length function before the sanitizing device begins dosing. A switch is configured to limit power to the sanitizing device, and is closed for the duration of time dictated by the dose-length function, and open for a duration of time dictated by the dose-interval function. The sanitizing device is configured to deliver a dose of sanitizing agent into the enclosure.

While the dosing methodology described above is the preferred embodiment, as an alternative, one could achieve similar results by configuring the output devise to deliver a continuous stream of sanitizing agent. The rate of output would vary as the temperature varies. In this alternative embodiment, the sanitizing devise output level would be adjusted to achieve the desired concentration of sanitizing agent for any given ambient temperature.

The advantage of the preferred embodiment is that for many antimicrobial agents, a shorter exposure to higher concentrations is more effective than longer exposure to lower concentrations. The preferred embodiment also minimizes operating time and energy consumption.

Another embodiment would be to “pulse” the output devise on and off to approximate a continuous output. In this embodiment the output rate from the sanitizing devise remains constant, but % of “on” time would vary as the temperature varies to achieve the desired concentration of sanitizing agent.

Again the preferred embodiment is more effective at reducing microbial populations and energy consumption.

### BRIEF DESCRIPTION OF THE DRAWINGS

A fuller understanding of the nature and objects of the present invention will become apparent upon consideration of the following detailed description taken in connection with the accompanying drawings in which:

FIG. 1 is one embodiment of the invention detailed in a flow chart;

FIG. 2 is one embodiment of the present invention used to control an ozone generator detailed in a schematic;

FIG. 3 is one embodiment of the dose interval function;

FIG. 4 is one embodiment of the dose length function;

FIG. 5 is one embodiment of the invention intended to illustrate the best mode wherein all the components may be arranged inside a waste enclosure.

### DETAILED DESCRIPTION OF THE PREFERRED EMBODIMENTS

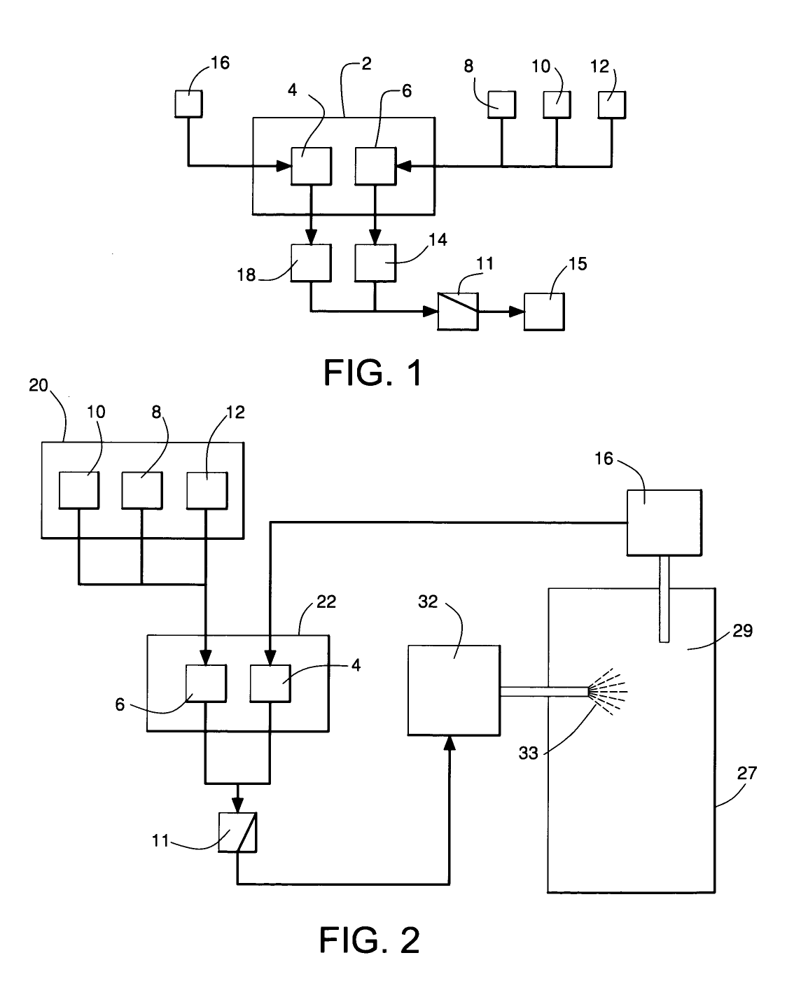

FIG. 1 shows one embodiment of the invention using a flow chart with a plurality of inputs for a control algorithm 2. A signal from at least one temperature sensor 16 is configured to be processed by a dose interval function 4. An output of the dose interval function 4 may be a dosing interval 18. A size of an enclosure 8, a sanitizing device output 10, and a desired concentration of sanitizing agent 12 are configured to provide inputs for a dose length function 6. The dose length function 6 determines a dose length 14. The dosing interval 18 and the dose length 14 may operate a switch 11, which may in turn operate an agent-producing sanitizing device 15.

The temperature sensor 16 may be any device that is able to sense temperature, such as a thermometer or thermocouple.

The dose interval function 4 may process inputs from the temperature sensor 16. The output of the dose interval function 4 is configured to be the dosing interval 18, which determines the time in between doses.

The size of the enclosure 8 may be measured in any units of volume, such as cubic inches, liters, cubic meters, gallons, etc.

The desired concentration of sanitizing agent 12 may be in any units of concentration, such as parts per million, molarity, molality, grams per liter, ounces per gallon, etc.

The sanitizing device output 10, refers to a rate of production of agent by the agent-producing sanitizing device 15, and may be measured in units produced per unit time, such as grams per minute, liters per hour, etc.

The switch 11 may be used as a mechanism to control the agent-producing sanitizing device 15 by turning it on or off.

The agent-producing sanitizing device 15 may be a device that can be controlled by temperature, such as an ozone generator, or an anti-odor or antibacterial aerosol.

FIG. 2 shows a schematic view of one embodiment of the present invention, and is not intended to limit the scope of the invention. A user interface 20 may be present for a manufacturer or user to input the sanitizing device output 10, the enclosure volume 8, and the desired concentration of sanitizing agent 12, which are configured to be parameters in the dose length function 6. The temperature sensor 16 senses an ambient temperature 29 inside a waste enclosure 27, and is configured to be a parameter in the dose interval function 4. The dose length function 6 and the dose interval function 4 are configured to be programmed into a programmable controller 22. The programmable controller 22, based on the dose length function 6 and dose interval function 4, is configured to operate the switch 11. The switch 11 is configured to control an ozone generator 32. The ozone generator 32 injects ozone 33 into the waste enclosure 27.

The sanitizing device output 10, the enclosure volume 8, and the desired concentration of sanitizing agent 12 may be entered by a user, installer, or manufacturer prior to, during, or after the installation of the invention.

The temperature sensor 16 may be used to sense an ambient temperature.

The programmable controller 22 may contain both the dose interval function 4 and the dose length function 6, and may be used to control the switch 11.

The ozone generator 32 is intended to be an example of a device that could be controlled by the ambient temperature 29, and is not intended to limit the scope of the invention.

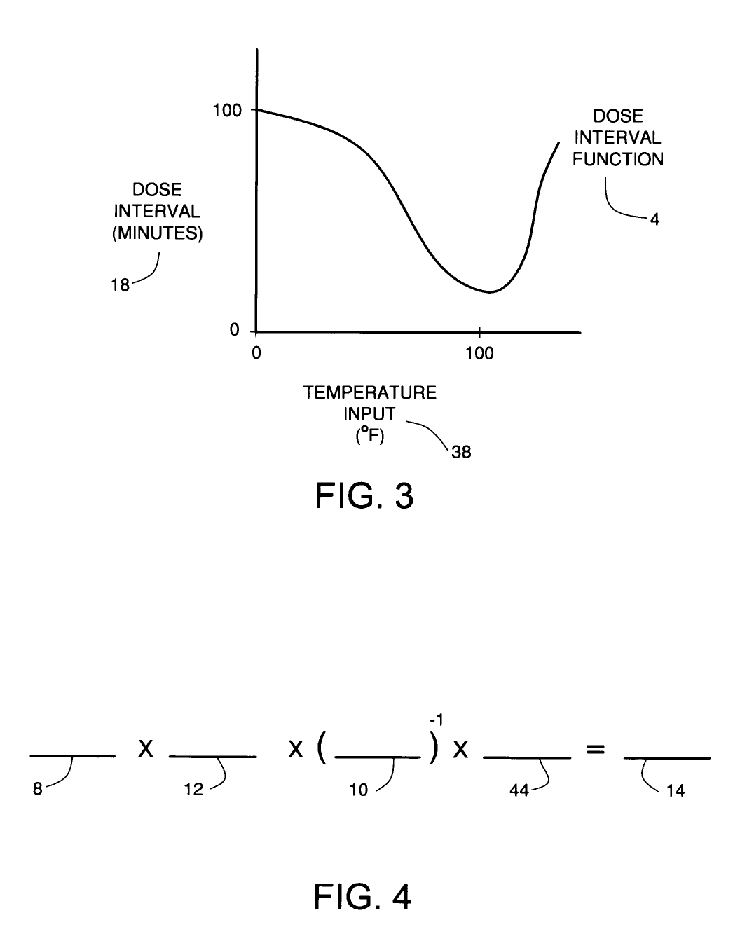

FIG. 3 shows one embodiment of the present invention, and is not intended to limit the scope of the invention. A temperature input 38 in units of temperature uses the dose interval function 4 to determine the dose interval 18 in units of time.

The temperature input 38 is shown in degrees Fahrenheit, but may be measured using other units of measurement such as Celsius or Kelvin. The temperature input 38 is configured to be supplied by the temperature sensor 16.

The dose interval function 4 shown is a function of temperature similar to a quadratic function of temperature, but different applications of the invention may require different functions of temperature. Thus, the dose interval function 4 may take the form of any function of temperature, such as linear, cubic, logarithmic, etc or empirical.

The dose interval 18 shown is measured in minutes, but may be measured using any division of time, such as seconds, hours, etc.

FIG. 4 shows one embodiment of the dose length function 6. The dose length function 6 may comprise the input for enclosure volume 8, the input for desired concentration of sanitizing agent 12, and the input for sanitizing device output 10, a conversion factor 44, and may be configured to produce an output of the dose length 14.

The enclosure volume 8 refers to the volume of the waste enclosure 27 in which the invention may reside. The volume can be measured in any unit of volume such as liters, gallons, etc.

The desired concentration of sanitizing agent 12 may be in any units of concentration, such as parts per million, molarity, molality, grams per liter, ounces per gallon, etc.

The sanitizing device output 10 may be in any units of output such as grams per minute, liters per hour, mg per hour, etc.

The conversion factor 44 may have the value of one and be unit-less if all the units of measurement for the enclosure volume 8, the desired concentration of sanitizing agent 12, and the sanitizing device output 10 are the same. If not, the conversion factor is meant to convert between units of mass, volume, time, etc. to produce the dose length 14 in units of time.

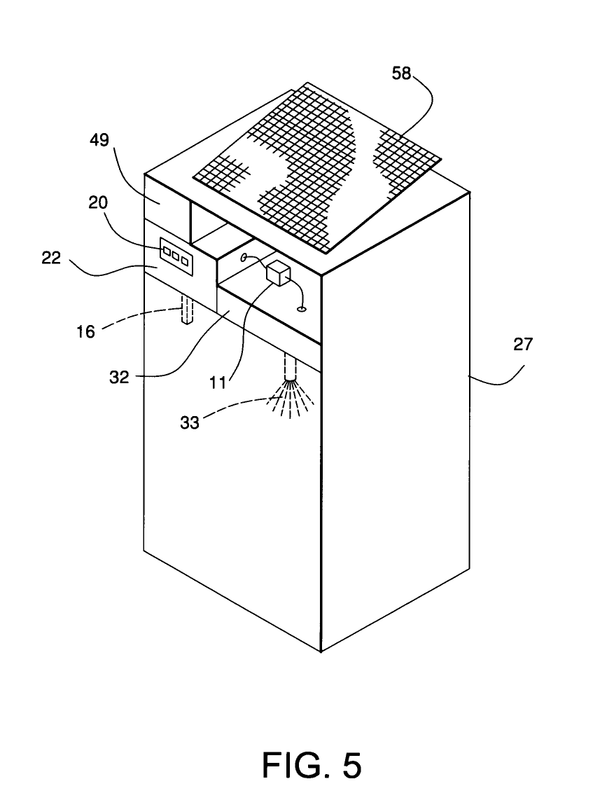

FIG. 5 shows an embodiment of the best mode of the invention at hand, comprising the temperature sensor 16, the programmable controller 22, the switch 11, the user interface 20, a battery 49, and the ozone generator 32, situated in the waste enclosure 27, preferably at the top of the waste enclosure 27, more preferably with the temperature sensor 16 configured to extend into the waste enclosure 27 and with the ozone generator 32 configured to deliver ozone 33 into the waste enclosure 27. A solar collector 58 is configured to provide power to all the components by charging the battery 49.

The temperature sensor 16 sends information to the programmable controller 22 as an input to the dose interval function 4. The programmable controller 22 operates the switch 11, which turns on or off the ozone generator 32.

What we claim is:

1. A controller for controlling a sanitizing device, comprising: a temperature-sensing component; a waste enclosure; a controlling component; and a response component
wherein the temperature-sensing component indirectly controls the response component through the controlling component;

2. The controller as claimed in claim 1 wherein the response element is a sanitizing device that is configured to deliver a sanitizing agent

3. The controller as claimed in claim 1 wherein the controlling component comprises a programmable unit that is configured to control a switch;

4. The controller as claimed in claim 1 wherein the controlling component comprises a dose-length function and a dose-interval function;

5. The controller as claimed in claim 4 wherein the dose-length function comprises a desired concentration of the sanitizing agent, a volume of the enclosure, a rate at which the sanitizing device delivers the sanitizing agent, and a dose-length time output;

6. The controller as claimed in claim 5 wherein the dose-length function controls a length of time of activity of the sanitizing device;

7. The controller as claimed in claim 4 wherein the dose-interval function comprises a temperature input and a time output which further comprises an interval in between doses of the sanitizing agent;

8. The controller as claimed in claim 7 wherein said interval in between doses of the sanitizing agent decreases as temperature increases if at least one of odor, microbial population, or microbial metabolism increases as temperature increases;

9. The controller as claimed in claim 7 wherein said interval in between doses of the sanitizing agent increases as temperature increases if at least one of odor, microbial population, or microbial metabolism decreases as temperature increases;

10. The controller as claimed in claim 4 wherein the switch is configured to turn the response component on or off;

11. The controller as claimed in claim 7 wherein a signal from the temperature-sensing component comprises the temperature input;

12. The controller as claimed in claim 1 wherein said temperature-sensing component is configured to be situated inside the waste enclosure such that it is able to sense an ambient temperature;

13. The controller as claimed in claim 1 wherein the response component is configured to deliver the sanitizing agent into the waste enclosure;

14. A method for controlling a sanitizing device, comprising a dose-length function and a dose-interval function, wherein the dose-interval function is configured generate a dose interval that is configured to be dependent on an ambient temperature inside an enclosure, and wherein the dose-length function is configured to generate a dose length that is configured to be directly proportional to a size of an enclosure, directly proportional to a desired sanitizing agent concentration, and inversely proportional to a rate of sanitizing agent production;

15. The method for controlling the sanitizing device as claimed in claim 14 wherein the ambient temperature inside the enclosure is measured by a temperature-sensing component configured to sense the ambient temperature inside the enclosure;

16. The method for controlling the sanitizing device as claimed in claim 15 wherein the temperature-sensing component sends a signal that comprises an input to the dose-interval function;

17. The method for controlling the sanitizing device as claimed in claim 14 wherein the size of the enclosure, the desired sanitizing agent concentration, and the rate of sanitizing agent production are configured to be input into the dose-length function;

18. The method for controlling a sanitizing device as claimed in claim 14 wherein a switch is configured to limit power to the sanitizing device;

19. The method for controlling a sanitizing device as claimed in claim 18 wherein the switch is configured to remain closed for a duration of time dictated by the dose-length function, and wherein the switch is configured to remain open for a duration of time dictated by the dose-interval function;

20. The method for controlling a sanitizing device as claimed in claim 14 wherein the sanitizing device is configured to deliver a dose of sanitizing agent into the enclosure.
